(19) United States
(12) Patent Application Publication
(10) Pub. No.: US 2026/0187839 A1
(43) Pub. Date: Jul. 2, 2026

(54) SYSTEMS AND METHODS FOR IMAGE KEYPOINTS AND CAMERA PARAMETERS DETECTION WITH THREE MACHINE LEARNING MODELS

(71) Applicants: Constructor Technology AG, Schaffhausen (CH); Constructor Education and Research Genossenschaft, Schaffhausen (CH)

(72) Inventors: Vladimir GOLOVKIN, Sofia (BG); Nikolay NEMTSEV, Sofia (BG); Sergey ULASEN, Singapore (SG); Andrei BOIAROV, Sofia (BG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/003,913

(22) Filed: Dec. 27, 2024

(51) Int. Cl. G06T 7/80; G06V 10/82; G06V 20/40

(52) U.S. Cl. CPC G06T 7/80; G06V 10/82; G06V 20/42

(57) ABSTRACT

A system executes a first machine learning model to identify camera parameters of an input image, and calculates a homography matrix based on the camera parameters. The system determines, using the homography matrix, a first set of pixel coordinates of a plurality of keypoints on the input image. The system executes a second machine learning model of a second type to identify at least one of the plurality of keypoints in the input image. The system determines, from an output of the second machine learning model, a second set of pixel coordinates of the plurality of keypoints on the input image. The system calculates a difference between the first set of pixel coordinates and the second set of pixel coordinates. In response to determining that the difference is greater than a threshold difference, the system executes a third machine learning model to identify enhanced camera parameters of the input image.

### FIELD OF TECHNOLOGY

The present disclosure relates to the fields of computer vision and machine learning, and, more specifically, to systems and methods for determining keypoints and camera parameters using machine learning.

### BACKGROUND

Precise tracking of players on the field during a football or soccer game is crucial for calculating players' speed of movement and other statistics, which can be utilized by coaches and football clubs to optimize player training. To accurately track football players on the image of the field, it is essential to determine their real-world coordinates and understand how these coordinates correspond to the image space. However, due to the low resolution of typical broadcast images of football games and the chaotic movement of pixels caused by the often rapid movement of the camera, accurately tracking players using pixel coordinates in the images is challenging. Even if a keypoints system is used instead of pixel coordinates, existing keypoints detection solutions are inaccurate, noisy, and slow. This results in poor prediction of player locations.

### SUMMARY

The present disclosure describes systems and methods that determine, using a first machine learning model, the camera parameters (e.g., pan, roll, field of view, etc.) of a camera capturing an image (e.g., of a soccer field). These camera parameters are used to determine a first set of keypoints in the image using a homography matrix. A second machine learning model (e.g., a convolutional neural network) configured to detect keypoints is then tasked with identifying a second set of keypoints in the image. Based on the difference between the first set of keypoints and the second set of keypoints, a third machine learning model that determines enhanced camera parameters is executed given the camera parameters output by the first machine learning model, the first set of keypoints, and the second set of keypoints—all as inputs.

In an exemplary aspect, the techniques described herein relate to a method for determining keypoints and camera parameters, the method including: executing a first machine learning model of a first type to identify camera parameters of an input image; calculating a homography matrix based on the camera parameters; determining, using the homography matrix, a first set of pixel coordinates of a plurality of keypoints on the input image, wherein the plurality of keypoints are prelabelled on a reference image; executing a second machine learning model of a second type to identify at least one of the plurality of keypoints in the input image; determining, from an output of the second machine learning model, a second set of pixel coordinates of the plurality of keypoints on the input image; calculating a difference between the first set of pixel coordinates and the second set of pixel coordinates; in response to determining that the difference is greater than a threshold difference, executing a third machine learning model to identify enhanced camera parameters, wherein the third machine learning model receives the camera parameters output by the first machine learning model, the first set of pixel coordinates, and the second set of pixel coordinates; and outputting the enhanced camera parameters.

In some aspects, the techniques described herein relate to a method, further including: identifying pixel coordinates of at least one object depicted in the input image; and generating planar coordinates of the at least one object on the reference image using another homography matrix calculated based on the new camera parameters.

In some aspects, the techniques described herein relate to a method, wherein the first type is a visual transformer neural network and the second type is a convolutional neural network.

In some aspects, the techniques described herein relate to a method, wherein the first machine learning model includes: a plurality of encoder blocks that each output a tensor of a different dimension; a fusion block that configures each of a plurality of tensors output by the plurality of encoder blocks to a same dimension and combines the plurality of configured tensors; a camera parameters block that generates camera parameter prediction; and a heatmap block that generates a heatmap prediction.

In some aspects, the techniques described herein relate to a method, wherein the input image depicts a sports field and the plurality of keypoints are landmarks on the sports field, and wherein the reference image depicts a two-dimensional aerial view of the sports field.

In some aspects, the techniques described herein relate to a method, wherein training of the first machine learning model and the second machine learning model is performed using a same training dataset including a plurality of images.

In some aspects, the techniques described herein relate to a method, wherein the training dataset includes a first plurality of real world images and a second plurality of synthetic images generated by a simulator.

In some aspects, the techniques described herein relate to a method, wherein the camera parameters include pan, roll, tilt, field of view (FOV), and real-world coordinates of a camera that generated the input image.

In some aspects, the techniques described herein relate to a method, further including: in response to determining that the difference is not greater than a threshold difference, outputting the camera parameters of the first machine learning model.

It should be noted that the methods described above may be implemented in a system comprising a hardware processor. Alternatively, the methods may be implemented using computer executable instructions of a non-transitory computer readable medium.

In some aspects, the techniques described herein relate to a system for determining keypoints and camera parameters, including: at least one memory; and at least one hardware processor coupled with the at least one memory and configured, individually or in combination, to: execute a first machine learning model of a first type to identify camera parameters of an input image; calculate a homography matrix based on the camera parameters; determine, using the homography matrix, a first set of pixel coordinates of a plurality of keypoints on the input image, wherein the plurality of keypoints are prelabelled on a reference image; execute a second machine learning model of a second type to identify at least one of the plurality of keypoints in the input image; determine, from an output of the second machine learning model, a second set of pixel coordinates of the plurality of keypoints on the input image; calculate a difference between the first set of pixel coordinates and the second set of pixel coordinates; in response to determining that the difference is greater than a threshold difference, execute a third machine learning model to identify enhanced camera parameters, wherein the third machine learning model receives the camera parameters output by the first machine learning model, the first set of pixel coordinates, and the second set of pixel coordinates; and output the enhanced camera parameters.

In some aspects, the techniques described herein relate to a non-transitory computer readable medium storing thereon computer executable instructions for determining keypoints and camera parameters, including instructions for: executing a first machine learning model of a first type to identify camera parameters of an input image; calculating a homography matrix based on the camera parameters; determining, using the homography matrix, a first set of pixel coordinates of a plurality of keypoints on the input image, wherein the plurality of keypoints are prelabelled on a reference image; executing a second machine learning model of a second type to identify at least one of the plurality of keypoints in the input image; determining, from an output of the second machine learning model, a second set of pixel coordinates of the plurality of keypoints on the input image; calculating a difference between the first set of pixel coordinates and the second set of pixel coordinates; in response to determining that the difference is greater than a threshold difference, executing a third machine learning model to identify enhanced camera parameters, wherein the third machine learning model receives the camera parameters output by the first machine learning model, the first set of pixel coordinates, and the second set of pixel coordinates; and outputting the enhanced camera parameters.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for determining keypoints and camera parameters using machine learning.

FIG. 2 is a diagram illustrating training inputs of the machine learning model.

FIG. 3 is a diagram illustrating the effect of homography on input images.

FIG. 4 is a block diagram illustrating the training process of the machine learning model.

FIG. 5 is a block diagram illustrating detailed structure the machine learning model.

FIG. 6 is a block diagram illustrating the fine-tuning stage of the trained machine learning model.

FIG. 7 illustrates a flow diagram of a method for determining keypoints and camera parameters using machine learning.

FIG. 8 presents an example of a general-purpose computer system on which aspects of the present disclosure can be implemented.

### DETAILED DESCRIPTION

Exemplary aspects are described herein in the context of a system, method, and computer program product for determining keypoints and camera parameters using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

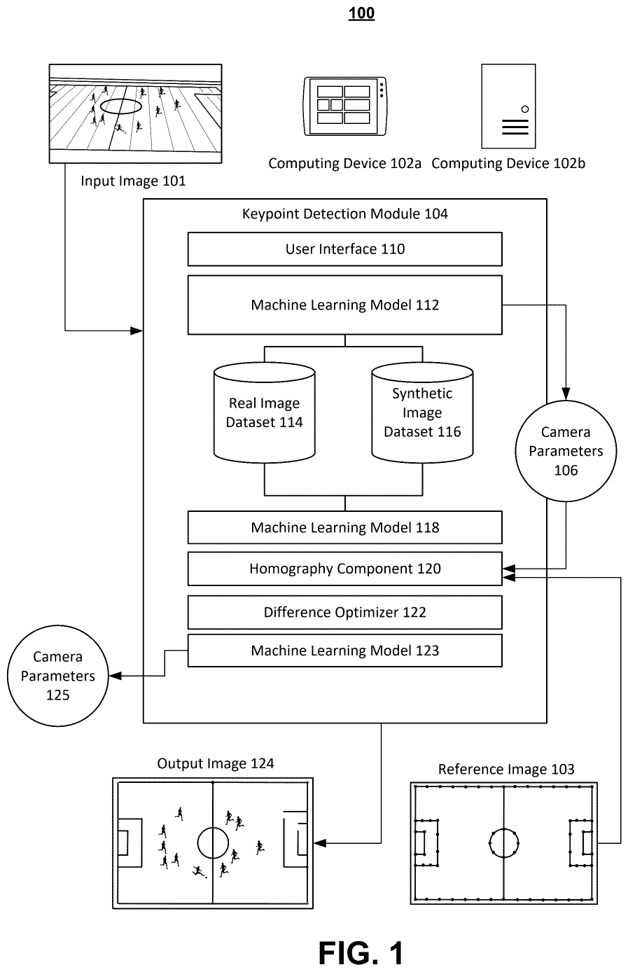

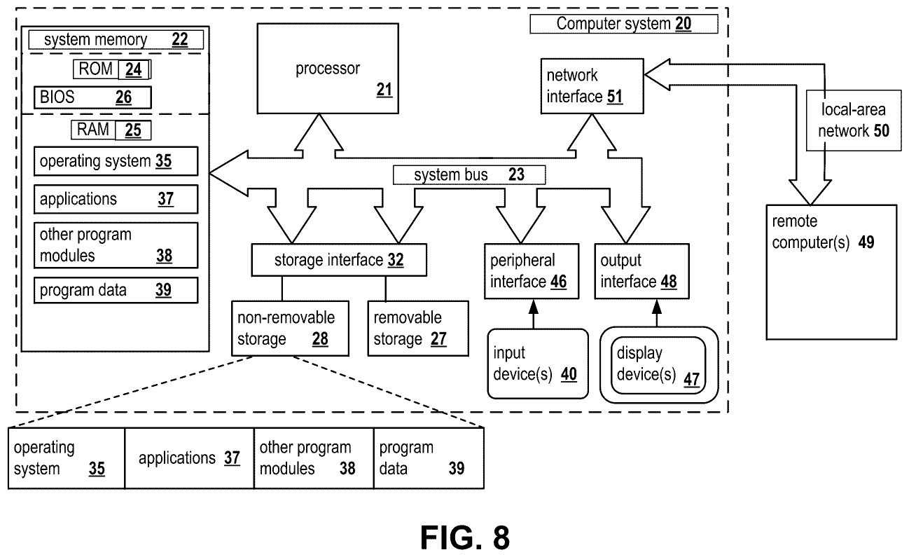

FIG. 1 is a block diagram illustrating system 100 for determining keypoints and camera parameters using machine learning. System 100 includes computing device 102a and computing device 102b. Both devices may execute some or all parts of keypoint detection module 104, which is configured to detect camera parameters 106 and keypoints of an input image 101. For example, computing device 102a may be a smartphone or a laptop that receives input image 101 and outputs camera parameters 125 and/or keypoints on a user interface 110. Computing device 102a may further transmit the input image 101 to computing device 102b, which may be a remote server that executes the other components of keypoint detection module 104 such as machine learning module 123 and homography component 120 to produce camera parameters 125 and keypoints. Computer system 20 in FIG. 8 details the possible structures of computing device 102a and computing device 102b.

In some aspects, input image 101 depicts a sports field. An objective of the present disclosure is to first identify a plurality of keypoints representing landmarks on the sports field. These keypoints may be prelabelled on a reference image 103, which is a two-dimensional aerial view of the sports field. Another objective of the present disclosure is to create a mapping (e.g., via a homography matrix) between the keypoints in reference image 103 and input image 101. Yet another objective of the present disclosure is to use the mapping to identify universal positions of objects detected in input image 101 on the two-dimensional aerial view and generate output image 124.

To determine camera parameters 106, keypoint detection module 104 may utilize machine learning model 112 (e.g., a custom Segformer). In some aspects, camera parameters 106 include, but are not limited to, the x, y, and z real-world coordinates of the camera, pan, roll, tilt (Euler angles), and field of view (FOV).

The first step involves training model 112 to detect camera parameters from field images using two extensive datasets: real image dataset 114 and synthetic image dataset 116. For example, dataset 114 may include 32,000 images from real soccer games and dataset 116 may include 40,000 simulated images (e.g., from the Google Football Simulator). Each of the images in the dataset may be labelled by camera parameters.

When an initial set of camera parameters is determined by machine learning model 112, a homography matrix is calculated. This homography matrix is used to map a plurality of keypoints on a reference image 103 to an image plane. Furthermore, another plurality of keypoints is determined by machine learning model 118, which accepts an image as an input, and uses image processing to approximate keypoints in the image.

Using the plurality of keypoints derived using the camera parameters of machine learning model 112 and the another plurality of keypoints output by machine learning model 118, the system determines whether there is a need to improve the camera parameters. If the difference between the respective pluralities of keypoints is small (e.g., less than a threshold), then the camera parameters of the first machine learning model are considered accurate enough (i.e., no need for further improvement). However, if the difference is greater than the threshold, machine learning model 123 is executed. In some aspects, the threshold difference is a value set by a user of keypoint detection module 104.

Machine learning model 123 receives the camera parameters 106 output by machine learning model 112 and uses it as an initial set of parameters. Machine learning model 123 further receives the keypoints derived from camera parameters 106 and the keypoints detected by machine learning model 118. The combination of inputs provides machine learning model 123 with the approximate parameters of the camera and the approximate locations of where the keypoints are located. Using both camera information and photo information, machine learning model 123 outputs camera parameters 125, which are the same parameters as camera parameters 106, albeit with adjusted values.

Machine learning model 123 is designed to refine camera parameters by integrating information from models 112 and 118, which provide initial camera parameters and keypoint data, respectively. The training process for model 123 may involve the following steps to ensure it can effectively adjust camera parameters based on the input data.

The training of model 123 may begin with the collection of comprehensive dataset(s) that include images, initial camera parameters, and keypoints. In some aspects, the dataset(s) may be real image dataset 114 and/or synthetic image dataset 116.

Preprocessing may then be performed, which may involve normalizing the camera parameters and keypoints to a consistent scale and format, which helps in reducing computational complexity and improving model accuracy. Additionally, data augmentation techniques such as rotation, scaling, and translation may be applied to the images to simulate different camera angles and positions, thereby enhancing the model's ability to generalize across different conditions.

The initial camera parameters from model 112 serve as a baseline for model 123, while the keypoints derived from model 112 and output by model 118 provide spatial information about the image. These inputs are transformed into a feature vector that captures the relationship between the camera's position and orientation and the detected keypoints. This feature vector is used by model 123 to understand how changes in camera parameters affect the keypoint mapping on the image plane.

The architecture of model 123 may be a neural network designed to handle regression tasks, as it outputs adjusted camera parameters. The network may comprise multiple layers, including convolutional layers for processing image data and fully connected layers for integrating camera parameters and keypoint information. During training, the model learns to minimize the difference between the two input sets of keypoints by adjusting predicted camera parameters. In some aspects, an input vector may further include a target camera parameter that achieves the minimal difference between two input sets of keypoints. During training, a loss function, such as mean squared error (MSE), may be used to minimize a loss between the target camera parameters and the initial camera parameters.

In some aspects, training involves iterative refinement, where the model's predictions are continuously compared against the ground truth. The model may be trained using a backpropagation algorithm, which adjusts the weights of the network to reduce the prediction error. Regular validation on a separate dataset may ensure that the model does not overfit to the training data and can generalize well to unseen images. Hyperparameter tuning, such as adjusting the learning rate and network architecture, is performed to optimize the model's performance.

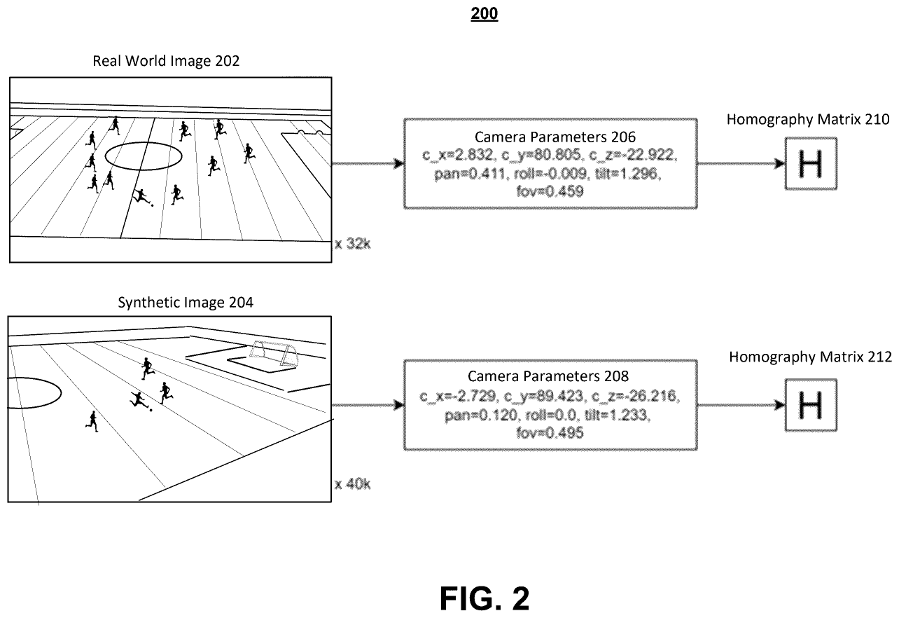

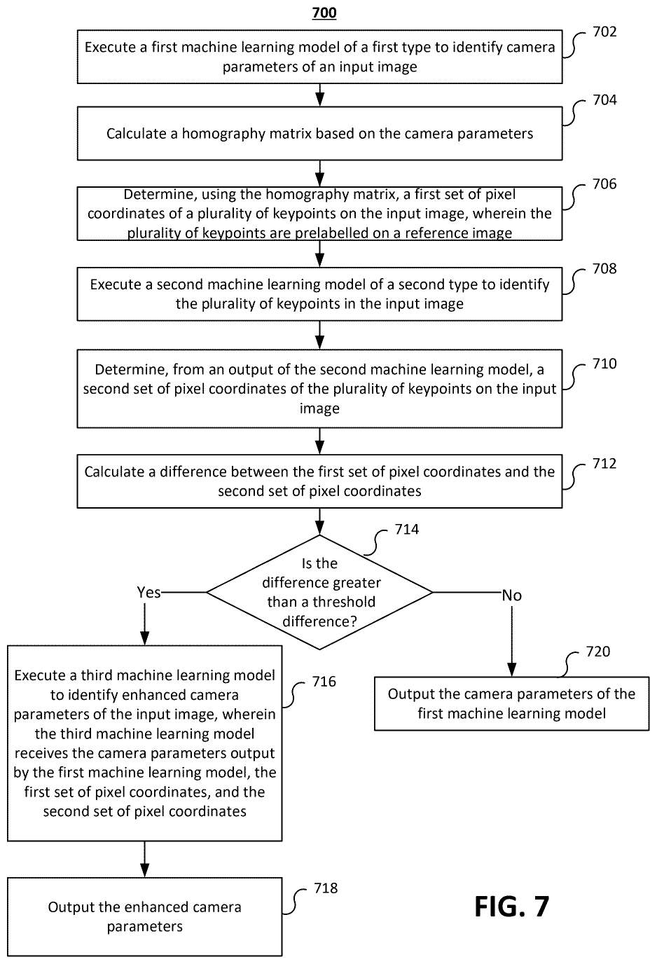

FIG. 2 is a diagram 200 illustrating training inputs of the machine learning model. For model training, the camera parameters for real images may be pre-determined (e.g., using a TVCalib method) while the simulated images may be pre-labeled with camera parameters. For example, camera parameters 206 may accompany real world image 202, whereas camera parameters 208 may be provided with synthetic image 204. Using these parameters, a homography matrix [H] is computed by homography component 120 for each input. For example, homography matrix 210 may be generated for real world image 202 and homography matrix 212 may be generated for synthetic image 204. An approach for calculating the homograph matrix is described in reference to FIG. 7. A homography matrix generally maps the 2D location of every pixel in the camera image (in the camera plane) to 2D coordinates (in the XY plane) in meters.

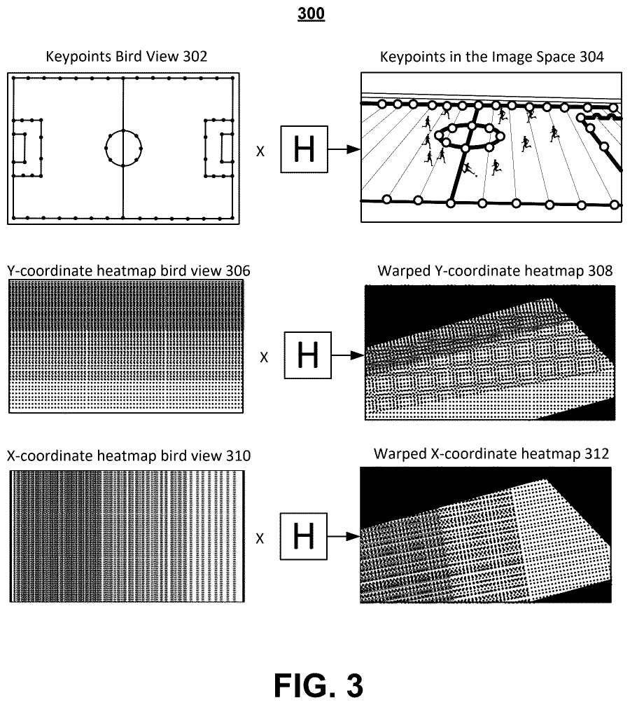

FIG. 3 is a diagram 300 illustrating the effect of homography on input images. For example, keypoints bird view 302 is converted, using a homography matrix, to achieve keypoints 304 in the image space. In terms of X and Y coordinates, Y-coordinate heatmap bird view 306 and X-coordinate heatmap bird view 310 are converted using a homography matrix to warped Y-coordinate heatmap 308 and warped X-coordinate heatmap 312. It should be noted that the shown heatmap images are representations of the keypoints in the real-world images when there is no limit to the amount of keypoints that may be used.

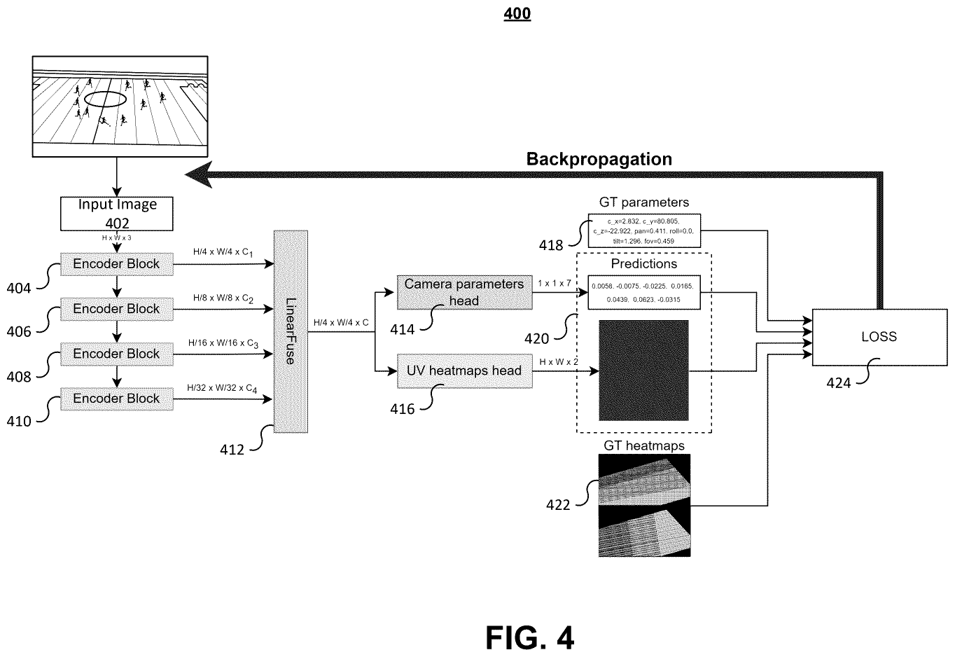

FIG. 4 is a block diagram 400 illustrating the training process of the machine learning model. Machine learning module 112 comprises a plurality of encoder blocks. In FIG. 4, four encoder blocks are shown, namely encoder blocks 404, 406, 408, and 410. The input matrix size of input image 402 is H×W×3 (where H is height and W is width of input image 402). The output matrix dimensions from encoder block 404 is H/4×W/4×C₁. The output matrix dimensions from encoder block 406 is H/8×W/8×C₂. The output matrix dimensions from encoder block 408 is H/16×W/16×C₃. The output matrix dimensions from encoder block 410 is H/32×W/32×C₄.

The outputs of each encoder block are added via LinearFuse block 412, which outputs a matrix with dimensions H/4×W/4×C. This matrix is input into camera parameter head 414 and UV heatmaps head 416. Camera parameters head 414 outputs a first vector (of size 1×1×7) and a second vector (of size H×W×2). These vectors are part of predictions 420. The first vector comprises predicted camera parameters. The second vector comprises a predicted heat map.

Predictions 420 are then compared against target camera parameters 418 and target heatmaps 422. A loss function is then used to compare the first vector against parameters 418 and the second vector against heatmaps 422. The determined loss 424 is then used to update the weights of the machine learning model 112 (namely each of the encoder blocks, LinearFuse block, and heads 414 and 416) via backpropagation.

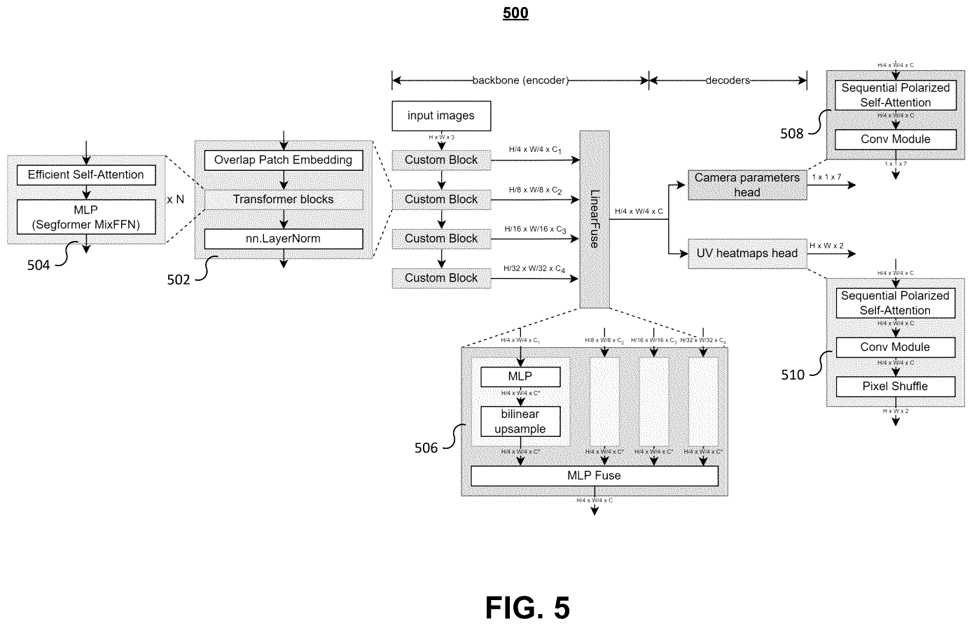

FIG. 5 is a block diagram 500 illustrating detailed structure the machine learning model 112. FIG. 5 provides a detailed structure of the machine learning model 112, focusing on the custom encoder blocks and their components. Each encoder block, such as 404, 406, 408, and 410, is a custom encoder block with a specific internal structure represented by block 502. Block 502 reveals that the custom encoder block performs overlap patch embedding, a technique used to process input data into overlapping patches for better feature extraction. The output from this embedding process is then passed through a series of transformer blocks, which are detailed in block 504. Block 504 illustrates that each transformer block incorporates efficient self-attention mechanisms and a Multi-Layer Perceptron (MLP) known as segformer MixFFN, designed to enhance the model's ability to capture complex patterns in the data. There can be multiple (N) transformer blocks within each encoder block, allowing for deep and nuanced data processing. Additionally, each custom encoder block includes nn.LayerNorm, a normalization layer that helps stabilize and accelerate the training process by normalizing the inputs across the batch. This detailed structure ensures that the machine learning model is both robust and efficient in handling various data inputs.

LinearFuse block 412 corresponds to block 506, which describes the internal components of LinearFuse block 412. For example, each output from the custom encoder blocks may be input in an MLP and undergo bilinear upsampling. This upsampling process adjusts the matrix dimensions of all four outputs to a uniform size of H/4×W/4×C, ensuring consistency in the data structure. Following the upsampling, each of the four upsampled outputs, which correspond to the outputs from the custom encoder blocks, is processed through an MLP fuse block. The MLP fuse block integrates these outputs and produces a final matrix with dimensions of H/4×W/4×C. This structured approach within the LinearFuse block 412 ensures that the data is effectively combined and standardized, facilitating further processing and analysis within the machine learning model.

Camera parameters head 414, represented by block 508, provides an expanded view of its internal components and processes. Block 508 includes sequential polarized self-attention, a mechanism that processes an input matrix with dimensions H/4×W/4×C and outputs a matrix of the same dimensions. This self-attention mechanism is designed to enhance the model's ability to focus on different parts of the input data, improving the accuracy and relevance of the extracted features. The output from the sequential polarized self-attention is then fed into a convolutional (conv) module. This conv module further processes the data and outputs a matrix with dimensions 1×1×7, which encapsulates the camera parameters.

UV heatmaps head 416, represented by block 510, provides an expanded view of its internal components and processes. Block 510 includes sequential polarized self-attention, a mechanism that processes an input matrix with dimensions H/4×W/4×C and outputs a matrix of the same dimensions. The output from the sequential polarized self-attention is then fed into a conv module. This conv module further processes the data and outputs a matrix with dimensions H/4×W/4×C, maintaining the same spatial dimensions but refining the feature representation. The refined output is then passed through a pixel shuffles block, which rearranges the data to produce heatmaps with dimensions H×W. These heatmaps are crucial for visualizing the intensity or probability of certain features across the spatial dimensions. Notably, two separate heatmaps are produced: one for the X-coordinates and one for the Y-coordinates, providing a comprehensive representation of the UV mapping.

During inference, real-time soccer field images are input into the trained ML model, which generates the camera parameters. Subsequently, the system calculates the homography matrix [H] from these parameters to determine the actual planar 2D XY coordinates of specific keypoints or players in the soccer field images based on their pixel location. Preliminary soccer field images can be analyzed using any image classification neural network to identify the pixel location of players, thereby providing the necessary pixel location data for each player. This approach ensures a more efficient and accurate tracking system for optimizing player performance and training.

The system's backbone (encoder) features a hierarchical Transformer encoder designed to extract both coarse and fine features. This encoder comprises four sequential “custom blocks” and a “LinearFuse” component.

The Overlap Patch Embedding decomposes an input image into a series of patches. Each patch is serialized into a vector and mapped to a smaller dimension through a single matrix multiplication. These vector embeddings are then processed by a transformer encoder as if they were token embeddings. The layer input size is [Hin, Win, Cin], where Win represents the input width, Hin the input height, and Cin the input channels. The layer output size is [B, Wout*Hout, Cout], where B is the batch size, Cout the channels size, Wout=[(Win−K+2P)//S]+1, and Hout=[(Hin−K+2P)//S]+1. Here, K denotes the patch size, S the stride between two adjacent patches, and P the padding size. For the first Overlap Patch Embedding layer, K=7, S=4, and P=3. For subsequent layers, K=3, S=2, and P=1.

The custom block includes N transformer blocks, utilizing a transformer encoder architecture tailored for visual tasks. Each transformer block consists of Efficient Self-Attention and Mi×FFN. The layer input size is [B, P, C], where B is the batch size, P the number of patches, and C the channels size. The layer output size is [B, P, C], maintaining the same dimensions as the input.

The nn.LayerNorm component applies layer normalization over a mini-batch of inputs, ensuring stable and efficient training by normalizing the inputs across the batch.

The LinearFuse component processes multi-level features Fi from the custom blocks encoder through a series of steps to produce a unified output tensor. Initially, these features pass through an MLP layer to standardize the channel dimensions. Subsequently, the features are up-sampled to ¼th of their original size and concatenated. Finally, an MLP layer fuses the concatenated features F.

$${\hat{F}}_{i} = Linear ( {C}_{i} , C ) ( {F}_{i} ) , ∀ i$$

$${\hat{F}}_{i} = Upsample ( \frac{W}{4} \times \frac{W}{4} ) ( {\hat{F}}_{i} ) , ∀ i$$

$$F = Linear ( 4 C , C ) ( Concat ( {\hat{F}}_{i} ) ) , ∀ i$$

Input: A list of 4 tensors with different sizes (¼, ⅛, 1/16, 1/32).
Output: A single tensor with dimensions [H/4, W/4, C].
The MLP layer, often referred to as “MLP conv layers” or 1×1 convolutions, standardizes the channel dimensions of the input tensors.
Layer Input size: [H*, W*, C*], where H*, W* is one of H/4, W/4 . . . H/32, W/32., and C1 . . . C4
Layer Output size: [H*, W*, C_fuse], C_fuse—will be the same for all 4 tensors

In the second step, all vectors are up-sampled to ¼th of their original size and concatenated.
Layer Input size: [H*, W*, C_fuse], where H*, W* is one of H/4, W/4 . . . H/32, W/32.
Layer Output size: [H/4, W/4, C_fuse]

The MLP fuse block concatenates all 4 tensors and applies a 1×1 convolution to produce the final image embedding.
Layer Input size: [H/4, W/4, 4*C_fuse]
Layer Output size: [H/4, W/4, C]

The system includes two decoder heads: Camera Parameters and UV Heatmap. Both decoder heads receive input tensors with dimensions [H/4, W/4, C], where H is the input height, W is the input width, and (C) is the embedding length.

The Camera parameters block is designed to produce target values and consists of two main blocks:

### Polarized Self-Attention

The polarized self-attention block is been optimized to balance representation capacity between its channel-only and spatial-only branches, resulting in minimal metric differences between sequential and parallel layouts.
Layer Input Size: [H/4, W/4, C]
Layer Output Size: [H/4, W/4, C](same as input)

The Conv2D block transforms the embedding into camera parameters using Conv2d layers with a nonlinear activation function and BatchNorm layers. The block concludes with an nn.AdaptiveAvgPool2d layer.
Layer Input Size: [H/4, W/4, C]
Layer Output Size: [1, 1, 7], representing the 7 camera parameters (x, y, z real-world coordinates of the camera, pan, roll, tilt Euler angles, and FOV).

The UV heatmaps head generates heatmaps for X and Y coordinates.
Layer Input Size: [H/4, W/4, C]
Layer Output Size: [H, W, 2], where the 2 channels correspond to the x and y coordinates heatmaps.

The loss 424 is a sum of a camera parameters loss and a heatmaps loss. In terms of camera parameters loss, from predicted camera parameters “params_pred” and ground truth camera parameters “params_gt,” keypoint detection module calculates homography matrixes H_pred and H_gt. Using H_gt, keypoint detection module can project canonical keypoints cano_kpts_gt from real-world coordinates to pixel coordinates frame_kpts_gt. Next keypoint detection module projects frame_kpts_gt keypoints back to real-world coordinates using H_pred getting cano_kpts_pred. Keypoint detection module further projects cano_kpts_gt to frame_kpts_pred.

The loss for the camera parameters block is thus:

$$camera\_parameters \_loss = {W}_{1} * L 2 ( cano\_kpts \_gt , cano\_kpts \_pred ) + {W}_{2} * L 2 ( frame\_kpts \_gt , frame\_kpts \_pred ) + {W}_{3} * L 1 ( params\_gt , params\_pred ) .$$

The Manhattan distance (L1 norm) and Euclidean distance (L2 norm) are two metrics used in machine learning models. The L1 norm is calculated by taking the sum of the absolute values of the vector. The L2 norm takes the square root of the sum of the squared vector values.

The heatmaps loss combines Dice loss with the standard binary cross-entropy (BCE) loss that is generally the default for segmentation models. Combining the two methods allows for some diversity in the loss, while benefitting from the stability of BCE. The final loss is given by: W₁*camera_parameters_loss+W₂*heatmaps_loss.

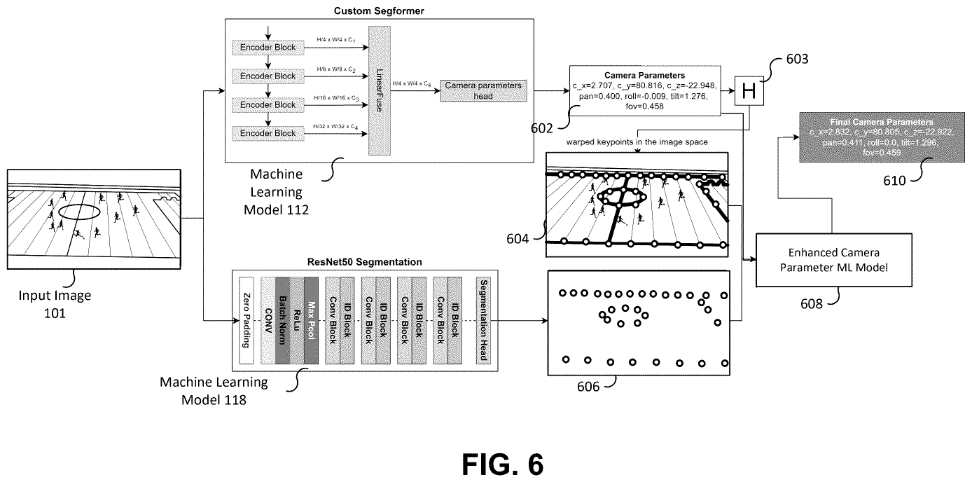

FIG. 6 is a block diagram 600 illustrating the inference stage of the trained machine learning model. During the inference stage, input image 101 is input into both machine learning model 112 and machine learning model 118. Machine learning model 118 may be a convolutional neural network trained to identify keypoints in the input image. For example, machine learning model 118 may be the ResNet50 Segmentation model shown in FIG. 6.

Machine learning model 112 outputs camera parameters 602, which is used by homography component 120 to determine a homography matrix 603. Using the homography matrix 603, keypoint detection module 104 maps the keypoints marked in reference image 103 to input image 101. The result of this mapping is image 604, which is labeled with a plurality of keypoints.

In parallel, machine learning model 118 outputs image 606, with a plurality of identified keypoints. Difference optimizer 122 then compares both sets of keypoints in images 604 and 606. If the amount of keypoints and their locations differ more than a threshold difference between images 604 and 606, camera parameters 602 and keypoints from images 604 and 606 are input into enhanced camera parameter machine learning model 608 (i.e., machine learning model 123). Model 608 is used to determine camera parameters 610 which are more accurate than camera parameters 602 in that the difference in keypoints from image 604 and 606 is minimized.

FIG. 7 illustrates a flow diagram of method 700 for determining keypoints and camera parameters using machine learning. At 702, keypoint detection module 104 executes a first machine learning model (e.g., model 112) of a first type to identify camera parameters of an input image (e.g., input image 101). In some aspects, the camera parameters comprise pan, roll, tilt, field of view (FOV), and real-world coordinates of a camera that generated the input image.

For example, consider an input image showing a soccer field during a match. The keypoint detection module 104 utilizes the first machine learning model trained on sports imagery to analyze the input image. The model identifies the pan as 30 degrees to the west, indicating the camera is oriented towards the left side of the field. It detects a roll of 0 degrees, suggesting the camera is perfectly level, and a tilt of 20 degrees downward, showing the camera is angled to capture the players and the ball on the field. The field of view (FOV) is calculated to be 75 degrees, covering a significant portion of the soccer field, including both the players and the goalposts. Additionally, the model determines the real-world coordinates of the camera relative to the center of the environment (e.g., (0,0,0) may the center of the soccer field)..

In some aspects, the first type is a visual transformer neural network. Accordingly, the first machine learning model comprises: (1) a plurality of encoder blocks (e.g., 4 blocks) that each output a tensor of a different dimension, (2) a fusion block that configures each of a plurality of tensors (e.g., 4 tensors—one for each block) output by the plurality of encoder blocks to a same dimension and combines the plurality of configured tensors (e.g., to produce a single tensor), (3) a camera parameters block that generates camera parameter prediction, and (4) a heatmap block that generates a heatmap predication.

For instance, consider an input image of a soccer field during a match. The visual transformer neural network processes this image through its encoder blocks, each extracting different levels of features from the image, such as player positions, field lines, and goalposts. This is a high-level example as the features are seldom readable by a human. Each encoder block outputs a tensor representing these features at varying dimensions. The fusion block then takes these tensors and reconfigures them to a uniform dimension, combining them into a single comprehensive tensor that encapsulates all the extracted features. The camera parameters block uses this combined tensor to predict the camera parameters. During the inference stage only the camera parameters block is used. The heatmap block is used only during the training stage. This is because a heatmap is densely distributed keypoints (or X,Y coordinates), which cannot be used as target values, as the output from this block is not robust enough.

At 704, keypoint detection module 104 calculates a homography matrix based on the camera parameters.

In some aspects, homography component 120 is configured to compute a homography matrix using intrinsic and extrinsic camera matrices comprising the determined camera parameters. The intrinsic camera matrix includes the camera's internal parameters, such as focal length (along x and y directions—fₓ and f_{y}) and optical center (along x and y directions—cₓ and c_{y}) and may be structured as:

$$K = ( \begin{matrix}{f}_{x} & 0 & {c}_{x} \\ 0 & {f}_{y} & {c}_{y} \\ 0 & 0 & 1\end{matrix} )$$

The extrinsic camera matrix describes the camera's position and orientation in the world. It combines a rotation matrix R and a translation vector t:

$$[ R \vert t ] = ( \begin{matrix}R & t \\ 0 & 1\end{matrix} )$$

Rotation around the front-to-back axis is called roll. Rotation around the side-to-side axis is called tilt (or pitch). Rotation around the vertical axis is called pan (or yaw).

Homography component 120 may derive the homography matrix H from the intrinsic and extrinsic parameters where, for a plane in 3D space, the relationship between the world coordinates P and image coordinates p can be expressed as:

$$p = K \cdot [ R \vert t ] \cdot P$$

$$p = H \cdot P$$

where H is the homography matrix.

Assuming the plane is at Z=0 (e.g., a soccer field), [R|t] is given by:

$$( \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} )$$

The complete formulation for the homography matrix may be expressed as:

$$H = ( \begin{matrix}{f}_{x} & 0 & {c}_{x} \\ 0 & {f}_{y} & {c}_{y} \\ 0 & 0 & 1\end{matrix} ) * ( \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} ) = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} )$$

In general, the homography matrix will always be different for each set of the camera parameters output by the visual transformer.

At 706, keypoint detection module 104 determines, using the homography matrix, a first set of pixel coordinates of a plurality of keypoints on the input image. The plurality of keypoints may be prelabelled in planar coordinates on reference image 103. The reference image, in this case, could be a bird's-eye view of the soccer field with keypoints labeled at significant locations such as the corners of the field, the center circle, the penalty spots, and the goalposts. Suppose the reference image has 74 keypoints, including detailed markings along the field lines. The module calculates a homography matrix, which is a transformation matrix that maps the points from the reference image to the input image. This matrix allows for the accurate overlay of the reference image onto the input image, effectively transforming the perspective of the reference image to match that of the input image.

For example, keypoint detection module 104 may generate keypoints 304 in an image space. Each keypoint may be defined by a pixel coordinate. Using the calculated homography matrix, keypoint detection module 104 maps the positions of the keypoints labelled in keypoints bird view 302 to keypoints 304. In some aspects, at least 4 keypoints are in the plurality of keypoints. In some aspects, 74 keypoints are in the plurality of keypoints.

At 708, keypoint detection module 104 executes a second machine learning model (e.g., model 118) of a second type to identify the plurality of keypoints in the input image. In some aspects, the second type is a convolutional neural network (CNN). The keypoints outputted by the second machine learning model are used to boost the precision of the camera parameters outputted by the first machine learning model (as described in step 712).

Consider an input image of a soccer field where the keypoints correspond to specific landmarks such as the goalposts, center circle, penalty spots, and corner flags. The CNN is trained to recognize these landmarks by analyzing the spatial patterns and features within the image. By processing the image through multiple convolutional layers, the CNN can detect and localize these keypoints.

At 710, keypoint detection module 104 determines, from an output of the second machine learning model, a second set of pixel coordinates of the plurality of keypoints on the input image.

At 712, keypoint detection module 104 calculates a difference between the first set of pixel coordinates and the second set of pixel coordinates. For example, the two corresponding pixel coordinates from each set may be given as (x1, y1) and (x2, y2). Difference optimizer 122 may calculate a distance between these two coordinates. Subsequently, difference optimizer 122 may calculate a total distance (i.e., the difference between all coordinates in the first set of pixel coordinates and the second set of pixel coordinates) by calculating an average distance of all calculated individual distances. In some aspects, the total distance is a sum of all individual distances.

At 714, keypoint detection module 104 determines whether the difference is greater than a threshold difference. If the difference is greater than the threshold difference, method 700 advances to 716. Otherwise, method 700 advances to 720.

At 716, keypoint detection module 104 executes a third machine learning model (e.g., model 123) to identify enhanced camera parameters of the input image. The third machine learning model receives the camera parameters output by the first machine learning model, the first set of pixel coordinates, and the second set of pixel coordinates. For example, the first machine learning model may output camera parameters 602, while the third machine learning model may output enhanced camera parameters 610.

At 718, keypoint detection module 104 may output the enhanced camera parameters. In some aspects, the accuracy of the enhanced camera parameters may be test by calculating a new homography matrix and subsequently determining a third set of pixel coordinates for a plurality of keypoints. The difference between the third set of pixel coordinates and the second set of pixel coordinates is expected to be lower than the difference between the first and second set (hence the “enhanced” title).

In some aspects, keypoint detection module 104 utilizes the enhanced camera parameters to detect the location of arbitrary objects (e.g., players, balls, etc.) in an input image and map them to planar coordinates of reference image 103. For example, keypoint detection module 104 may identify pixel coordinates of at least one object (e.g., using the second machine learning model). Keypoint detection module 104 may then generate planar coordinates of the at least one object using another homography matrix calculated based on the enhanced camera parameters. For example, given the enhanced camera parameters, keypoint detection module 104 may calculate a new homography matrix and use the new homography matrix to map the pixel coordinates of the at least one object to two-dimensional planar coordinates (on the reference image). This gives a universal position of the at least one object (e.g., where the athlete is on the soccer field relative to all other athletes).

In the event that the difference is not greater than the threshold difference, at 720, keypoint detection module 104 outputs the camera parameters originally detected by the first machine learning model. In this case, no further improvements are needed on the parameters and they can be used to map arbitrary objects to reference image 103.

In some aspects, keypoint detection module 104 generates the reference image on user interface 110 and generates an icon representing the detected object on the generated planar coordinates. For example, user interface 110 may depict output image 124 of the soccer field and player locations on the field.

In some aspects, the training of the first machine learning model and the second machine learning model is performed using a same training dataset comprising a plurality of images. In some aspects, the training dataset comprises a first plurality of real world images (e.g., from real image dataset 114) and a second plurality of synthetic images generated by a simulator (e.g., from synthetic image dataset 116).

The system of the present disclosure offers many improvements in conventional computer vision systems. The system employs a custom vision transformer backbone, characterized by a high inference time of approximately 15 milliseconds depending on the hardware (e.g., NVIDIA GPU, such as A100, or RTX4090). This design facilitates the tracking of camera parameters and the detection of camera movements, making it suitable for visualizing 3D scenes and moments from soccer matches. The system demonstrates greater stability compared to the keypoints approach. Inference is performed once to predict camera parameters for a given image, yielding two outputs from a single input: actual camera parameters and a keypoints map. Once keypoints in the image space are identified, the system can determine the actual location of players relative to these keypoints. Although the illustrations primarily show keypoints of field lines, numerous other keypoints on the field can contribute to more accurately locating the players.

FIG. 8 is a block diagram illustrating a computer system 20 on which aspects of systems and methods for determining keypoints and camera parameters using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and otherfunctions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for determining keypoints and camera parameters, the method comprising:
executing a first machine learning model of a first type to identify camera parameters of an input image;
calculating a homography matrix based on the camera parameters;
determining, using the homography matrix, a first set of pixel coordinates of a plurality of keypoints on the input image, wherein the plurality of keypoints are prelabelled on a reference image;
executing a second machine learning model of a second type to identify at least one of the plurality of keypoints in the input image;
determining, from an output of the second machine learning model, a second set of pixel coordinates of the plurality of keypoints on the input image;
calculating a difference between the first set of pixel coordinates and the second set of pixel coordinates;
in response to determining that the difference is greater than a threshold difference, executing a third machine learning model to identify enhanced camera parameters of the input image, wherein the third machine learning model receives the camera parameters output by the first machine learning model, the first set of pixel coordinates, and the second set of pixel coordinates; and
outputting the enhanced camera parameters.

2. The method of claim 1, further comprising:
identifying pixel coordinates of at least one object depicted in the input image; and
generating planar coordinates of the at least one object on the reference image using another homography matrix calculated based on the enhanced camera parameters.

3. The method of claim 1, wherein the first type is a visual transformer neural network and the second type is a convolutional neural network.

4. The method of claim 3, wherein the first machine learning model comprises:
a plurality of encoder blocks that each output a tensor of a different dimension;
a fusion block that configures each of a plurality of tensors output by the plurality of encoder blocks to a same dimension and combines the plurality of configured tensors;
a camera parameters block that generates camera parameter prediction; and
a heatmap block that generates a heatmap predication.

5. The method of claim 1, wherein the input image depicts a sports field and the plurality of keypoints are landmarks on the sports field, and wherein the reference image depicts a two-dimensional aerial view of the sports field.

6. The method of claim 1, wherein training of the first machine learning model and the second machine learning model is performed using a same training dataset comprising a plurality of images.

7. The method of claim 6, wherein the training dataset comprises a first plurality of real world images and a second plurality of synthetic images generated by a simulator.

8. The method of claim 1, wherein the camera parameters comprise pan, roll, tilt, field of view (FOV), and real-world coordinates of a camera that generated the input image.

9. The method of claim 1, further comprising:
in response to determining that the difference is not greater than a threshold difference, outputting the camera parameters of the first machine learning model.

10. A system for determining keypoints and camera parameters, comprising:
at least one memory; and
at least one hardware processor coupled with the at least one memory and configured, individually or in combination, to:
execute a first machine learning model of a first type to identify camera parameters of an input image;
calculate a homography matrix based on the camera parameters;
determine, using the homography matrix, a first set of pixel coordinates of a plurality of keypoints on the input image, wherein the plurality of keypoints are prelabelled on a reference image;
execute a second machine learning model of a second type to identify at least one of the plurality of keypoints in the input image;
determine, from an output of the second machine learning model, a second set of pixel coordinates of the plurality of keypoints on the input image;
calculate a difference between the first set of pixel coordinates and the second set of pixel coordinates;
in response to determining that the difference is greater than a threshold difference, execute a third machine learning model to identify enhanced camera parameters of the input image, wherein the third machine learning model receives the camera parameters output by the first machine learning model, the first set of pixel coordinates, and the second set of pixel coordinates; and
output the enhanced camera parameters.

11. The system of claim 10, wherein the at least one hardware processor is further configured to:
identify pixel coordinates of at least one object depicted in the input image; and
generate planar coordinates of the at least one object on the reference image using another homography matrix calculated based on the enhanced camera parameters.

12. The system of claim 10, wherein the first type is a visual transformer neural network and the second type is a convolutional neural network.

13. The system of claim 12, wherein the first machine learning model comprises:
a plurality of encoder blocks that each output a tensor of a different dimension;
a fusion block that configures each of a plurality of tensors output by the plurality of encoder blocks to a same dimension and combines the plurality of configured tensors;
a camera parameters block that generates camera parameter prediction; and
a heatmap block that generates a heatmap prediction.

14. The system of claim 10, wherein the input image depicts a sports field and the plurality of keypoints are landmarks on the sports field, and wherein the reference image depicts a two-dimensional aerial view of the sports field.

15. The system of claim 10, wherein training of the first machine learning model and the second machine learning model is performed using a same training dataset comprising a plurality of images.

16. The system of claim 15, wherein the training dataset comprises a first plurality of real world images and a second plurality of synthetic images generated by a simulator.

17. The system of claim 10, wherein the camera parameters comprise pan, roll, tilt, field of view (FOV), and real-world coordinates of a camera that generated the input image.

18. The system of claim 10, wherein the at least one hardware processor is further configured to:
in response to determining that the difference is not greater than a threshold difference, output the camera parameters of the first machine learning model.

19. A non-transitory computer readable medium storing thereon computer executable instructions for determining keypoints and camera parameters, including instructions for:
executing a first machine learning model of a first type to identify camera parameters of an input image;
calculating a homography matrix based on the camera parameters;
determining, using the homography matrix, a first set of pixel coordinates of a plurality of keypoints on the input image, wherein the plurality of keypoints are prelabelled on a reference image;
executing a second machine learning model of a second type to identify at least one of the plurality of keypoints in the input image;
determining, from an output of the second machine learning model, a second set of pixel coordinates of the plurality of keypoints on the input image;
calculating a difference between the first set of pixel coordinates and the second set of pixel coordinates;
in response to determining that the difference is greater than a threshold difference, executing a third machine learning model to identify enhanced camera parameters of the input image, wherein the third machine learning model receives the camera parameters output by the first machine learning model, the first set of pixel coordinates, and the second set of pixel coordinates; and
outputting the enhanced camera parameters.
